(19) United States
(12) Patent Application Publication
(10) Pub. No.: US 2018/0311927 A1
(43) Pub. Date: Nov. 1, 2018

(54) CELLULAR STRUCTURE

(71) Applicant: FORD GLOBAL TECHNOLOGIES, LLC, Dearborn, MI (US)

(72) Inventor: Tau TYAN, Northville, MI (US)

(21) Appl. No.: 15/498,230

(22) Filed: Apr. 26, 2017

(51) Int. Cl. B32B 3/12

(52) U.S. Cl. CPC B32B 3/12

(57) ABSTRACT

A cellular structure includes a plurality of walls extending in a longitudinal direction and forming a plurality of cells adjacently arranged along a laterally extending plane. Each cell has a cross-section along the plane that includes fourteen sides formed by the plurality of walls. The fourteen sides of each cell are joined to each other to form a closed loop and six outward extending protrusions.

### TECHNICAL FIELD

The present disclosure relates to cellular structures.

### BACKGROUND

Cellular structures are utilized in several industries to improve structural integrity of a given product and/or to protect individuals that may be using or operating a given product.

### SUMMARY

A cellular structure includes a web of cells having shared walls. The cells each include two end walls joined at four end corners with two expanded fan-fold sidewalls that extend between the two end walls. Each sidewall has six planar sections forming three external corners and two internal corners.

A cellular structure includes a plurality of walls extending in a longitudinal direction and forming a plurality of cells adjacently arranged along a laterally extending plane. Each cell has a cross-section along the plane that includes fourteen sides formed by the plurality of walls. The fourteen sides of each cell are joined to each other to form a closed loop and six outward extending protrusions.

A cell structure includes a plurality of walls extending in a longitudinal direction and forming a cross-sectional area on a laterally extending plane. The cross-sectional area includes fourteen sides formed by the plurality of walls. The fourteen sides are joined to each other to form a closed loop and six outward extending protrusions.

### BRIEF DESCRIPTION OF THE DRAWINGS

FIG. 1 is a perspective view of a cellular structure;

FIG. 2 is a top view of the cellular structure;

FIG. 3 is a top view of a second embodiment of the cellular structure;

FIG. 4 is a side view of an alternative embodiment of an individual cell of the cellular structure;

FIG. 5 is a top view of the alternative embodiment of the individual cell;

FIG. 6 is a cross-sectional view of the alternative embodiment of the individual cell taken along line 6-6 in FIG. 4;

FIG. 7 illustrates a perspective view of an exemplary embodiment of a sandwich structure employing the cellular structure; and

FIG. 8 illustrates a perspective cutaway view of the exemplary embodiment of the sandwich structure.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

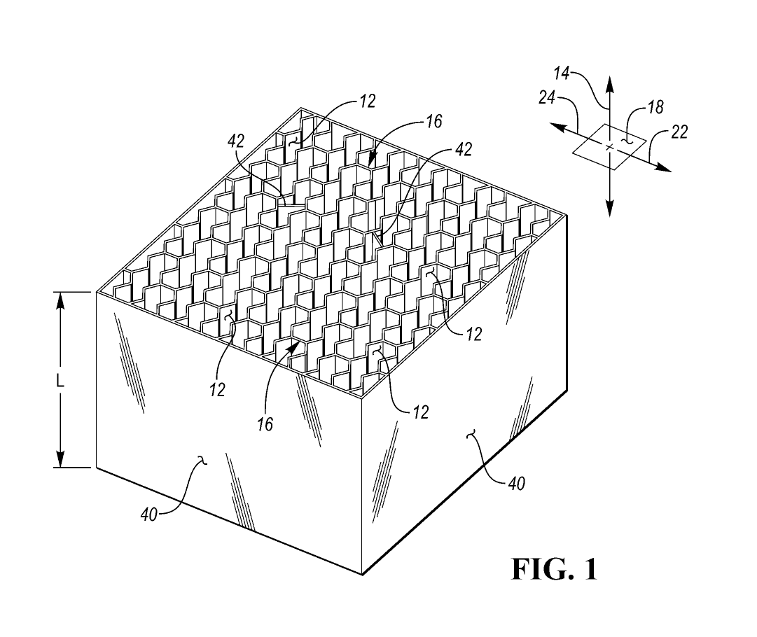

Referring to FIGS. 1 and 2, a perspective view and a top view of a cellular structure 10 are illustrated, respectively. The cellular structure 10 includes a plurality of walls 12 extending in a longitudinal direction 14. The plurality of walls 12 form a plurality of adjacently arranged cells 16 that are arranged along a laterally extending plane 18 (alternatively, it may be stated that the cellular structure 10 has a web of cells 16 that have shared walls 12). The laterally extending plane 18 may be substantially perpendicular to the longitudinal direction 14. Substantially perpendicular may refer to any incremental value that ranges from 85° to 95°. Each cell 16 has a cross-section (or cross-sectional area) along the laterally extending plane 18 that includes fourteen sides that are formed by the plurality of walls 12.

The fourteen sides of each cell 16 are joined to each other to form a closed loop and six outward extending protrusions 20. Each protrusion 20 of each cell 16 is formed by two of the fourteen sides. An angle 21 between the two of the fourteen sides that form each protrusion 20 of each cell 16 may be an obtuse, right, or acute angle. A first set of three protrusions of the six protrusion 20 of each cell 16 may extend outward in a first direction 22 along the laterally extending plane 18 and a second set of three protrusions of the six protrusions 20 of each cell 16 may extend outward in a second direction 24 along the laterally extending plane 18. The second direction 24 may be opposite relative to the first direction 22 along the laterally extending plane 18 (i.e., the second direction 24 may be oriented 180° relative to the first direction 22 along the laterally extending plane 18).

Each cell 16 also includes two end walls 26 formed by two of the fourteen sides that are joined to two expanded fan-fold sidewalls 28 at four end corners 30. The two end walls 26 may be substantially parallel to each other. Substantially parallel may refer to any incremental value between plus or minus 5° from exactly parallel. The expanded fan-fold sidewalls 28 of each cell 16 extend between the two end walls 26 and are formed by six planar sections 32, the six planar sections 32 being six of the fourteen sides of each cell 16. The two end walls 26 and the two expanded fan-fold sidewalls 28 may extend in one direction (i.e., the longitudinal direction 14), which may be a direction in which the cellular structure 10 is expected to receive an impact (i.e., an expected impact direction). The cross-section of each cell 16 may be oriented substantially perpendicular to the longitudinal direction 14 and the expected impact direction. Substantially perpendicular may refer to any incremental value that ranges from 85° to 95°. The protrusions 20 of the first and second sets of three protrusions of each cell 16 may be formed by the first and second expanded fan-fold sidewalls 28 of each cell 16, respectively.

The six planar sections 32 of each expanded fan-fold sidewall 28 of each cell 16 also form three external corners 34 that extend outward from a central space (or cavity) 36 defined by the fourteen sides of each cell 16 and two internal corners 38 that extend inward toward the central space 36 of each cell 16. The external corners 34 and the internal corners 38 may have various bend radii.

Each cell 16 has a total of fourteen corners (four end corners 30, six external corners 34, and four internal corners 38). Testing has indicated that cellular structures having fourteen cornered cells absorb more energy and require an increased force to displace the cellular structure along an expected impact direction when compared to cellular structures having either four or six cornered cells. Testing has further indicated that cellular structures having fourteen cornered cells absorb more energy and require an increased force to displace the cellular structure along an expected impact direction, while also having more regular crush patterns, smaller folding lengths, smaller dimensions, less material, a lower total mass and a lower total number cells, when compared to cellular structures having either four or six cornered cells.

Under quasi-static loading testing conditions, cellular structures having fourteen cornered cells were able to withstand higher quasi-static forces without exhibiting plastic or permanent deformation when compared to cellular structures having either four or six cornered cells. Under quasi-static loading conditions where plastic or permanent deformation occurred, the deformation of the cellular structures having fourteen cornered cells was less severe and more concentrated or localized when compared to cellular structures having either four or six cornered cells, resulting in a condition that was easier and less costly to repair when compared to cellular structures having either four or six cornered cells. To achieve similar performances in quasi-static loading conditions when compared to cellular structures having either four or six cornered cells, fourteen cornered cellular structures require a smaller design space, smaller dimensions, lower total number of cells, less material, and a lower total mass.

The plurality of walls 12 of each cell 16 may have a longitudinal length, L, and a thickness, T. A ratio between the longitudinal length, L, and the thickness, T, i.e., L/T, may be at least 1 to 100 (small L to large T ratios may be utilized in products such as shoe insoles, protective skins for phones or mobile devices, and/or backing or reinforcing ribs for molding or casting parts). The ratio between the longitudinal length, L, and the thickness, T, i.e., L/T, may be as great as 10,000 to 1 (Large L to small T ratios may be utilized in products such as composite or honeycomb materials). The plurality of walls 12 may maintain a constant or variable thicknesses, T, along the longitudinal length, L, of each cell 16 to control local or global properties (in-plan or out-of-plan stress, strain, stiffness, peak load, crush force, crush energy, deformation pattern) based on the desired application and/or in anticipation of expected loads whether they be local or global. Furthermore, the thickness of each individual side of the fourteen sides of each cell 16 may vary or may be fine-turned independently for desired local or global properties.

The central space 36 of one or more cells 16 of the cellular structure 10 may be filled with deformable structures or foam materials. The deformable structures or foam materials may increase the structural integrity of the cellular structure 10, increase the ability to absorb energy during an impact, or may be utilized for other desirable functions, such as thermal or sound insulation. Plates (or sheets) 40 may also be joined to the outside surfaces (top, bottom and four sides) of the cellular structure 10. Please note that a plate 40 is not shown on the top surface in FIG. 1 for illustrative purposes (i.e., so that the individual cells 16 may be observed). The plates 40 may also increase the structural integrity of the cellular structure 10, increase the ability to absorb energy during an impact, or may be utilized for other desirable functions, such as thermal or sound insulation. Internal support ribs 42 or webs may be disposed in the central space 36 of one or more cells 16 of the cellular structure 10. The internal support ribs 42 may be secured to at least two to the fourteen sides of each of the one or more cells 16 that include internal support ribs. The internal support ribs 42 may increase the structural integrity of the cellular structure 10 and/or increase the ability to absorb energy during an impact.

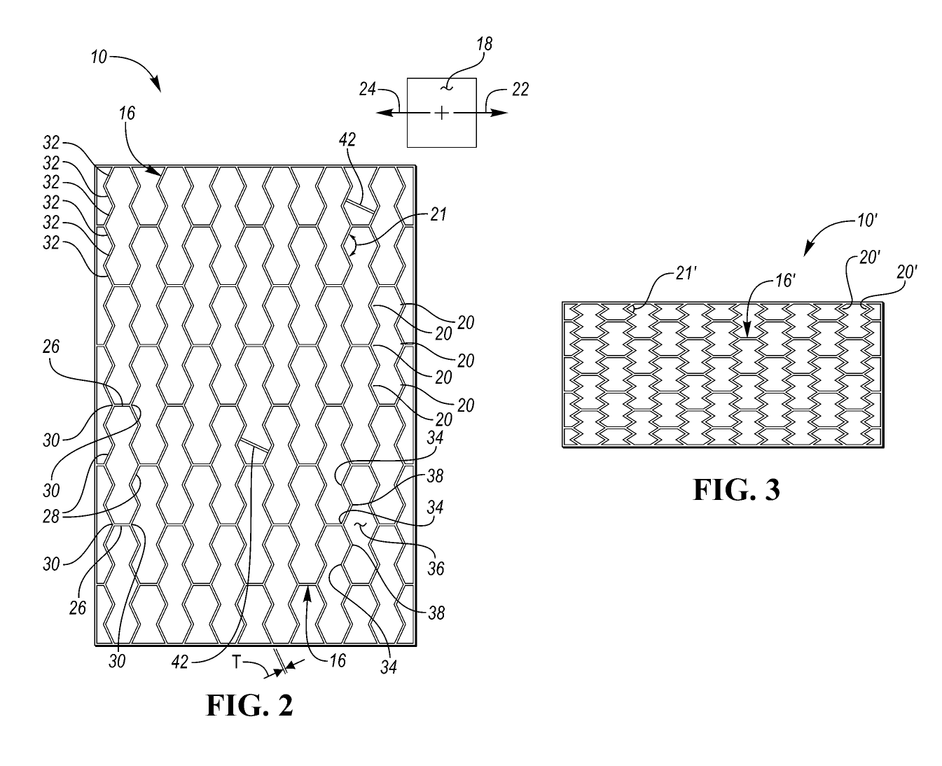

Referring to FIG. 3, a top view of an alternative embodiment of the cellular structure 10′ is illustrated. Unless otherwise stated herein, the alternative embodiment of the cellular structure 10′ should be construed to have all of the attributes of the cellular structure 10 described in FIGS. 1 and 2. The alternative embodiment of the cellular structure 10′ differs from cellular structure 10 in that the angle 21′ between the two of the fourteen sides that form each protrusion 20′ of each cell 16′ is an acute angle.

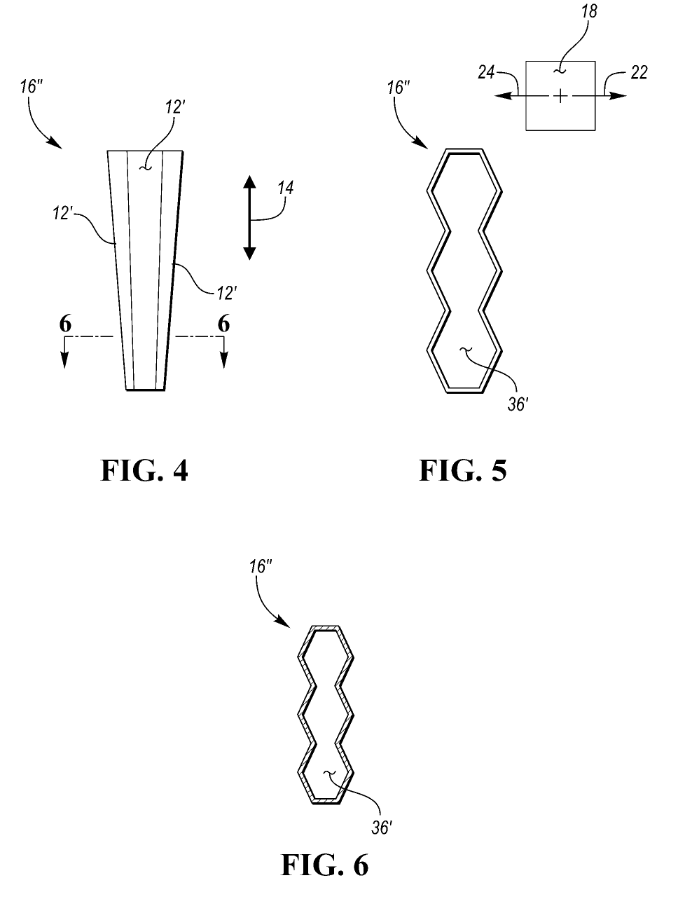

Referring to FIGS. 4-6, an alternative embodiment of the cellular structure 16″ of the cellular structure 10 is illustrated. Unless otherwise stated herein, the alternative embodiment of the cellular structure 16″ should be construed to have all of the attributes of the cells 16 described in FIGS. 1 and 2. The plurality of walls 12′ of the alternative embodiment of the cellular structure 16″ taper in the longitudinal direction 14 such that a cross-sectional area of the central space 36′ defined by the fourteen sides of each cell decreases extending in the longitudinal direction 14.

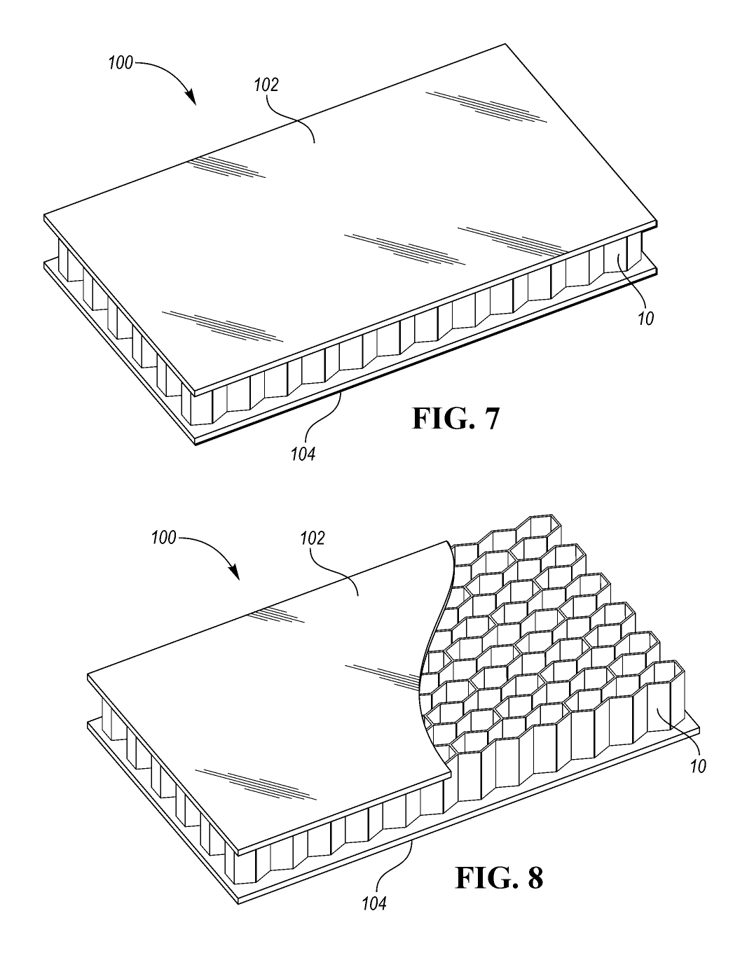

Referring to FIGS. 7 and 8, a sandwich structure 100 employing the cellular structure 10 is illustrated. The sandwich structure 100 has a core comprised of the cellular structure 10 with two substantially planar structures on opposing sides of the cellular structure 10 to form the sandwich structure 100. The cellular structure 10 is disposed between a top panel 102 and a bottom panel 104 in the sandwich structure 100. Top and bottom panels 102 and 104 may be in the form of any type of substantially planar structure. The substantially planar structures may be made of, for example, paper, wood, steel alloys, aluminum alloys, magnesium alloys, titanium alloys, polymers, or carbon or glass fiber reinforced composites. The substantially planar structures may be opaque, translucent, clear, etc. For example, one of the substantially planar structures may be clear or translucent to allow an observer of the product containing the cellular structure 10 to see a portion of the cellular structure 10, such that the cellular structure 10 forms a part of the aesthetic design of the product. The substantially planar structures may be formed integrally with the cellular structure 10 via conventional means such as molding and/or casting. Alternatively, the substantially planar structures may be bonded, coupled, or otherwise affixed to the cellular structure 10 via any conventional means, such as adhesion, lamination, mechanical fastening and/or welding.

The plurality of walls 12 that form the cellular structure 10, the plates 40 that are joined to the outside surfaces (if any), and the internal support ribs 42 may be made from steel alloys, titanium alloys, aluminum alloys, magnesium alloys, nylons, polymers, plastics, composites, fiber-reinforced composites, silicone, semiconductor materials, paper, carboard, shape-memory materials, rubber, foam, gel, hybrid materials (i.e., combinations of dis-similar materials), or any other suitable materials.

Each cell 16 size may be adjusted and can be optimized to meet different local or global property requirements. Layers and blocks of cellular structures with different cell sizes or materials can be also joined together to obtain different local or global properties based on the desired application and/or in anticipation of expected loads whether they are local or global. The same or different layers of cellular structures may be layered and adhered together with or without plates in between the layers. The cross-section can be tapered along the vertical axis (i.e., the longitudinal direction 14 or expected impact direction), as shown in FIG. 4.

The cellular structure 10 may be produced by stamping, bending, press forming, hydro-forming, molding, casting, extrusion, uniform or non-uniform roll forming, machining, forging, 3-D printing, or any other suitable manufacturing processes.

The cellular structure 10 may be utilized in the automotive industry to construct (1) integrated cellular structures such as crush cans, front rails, mid rails, side rails, or rear rails (e.g. extruded aluminum rails, molded carbon fiber reinforced polymer/composite rails, etc.); (2) structural internal inserts and/or external energy absorbing devices such as rockers, A/B/C/D-pillars, shutguns, roof rails, bows, panels, cross-members, doors, floors, hoods, deck-lids, lift-gates, or any other load carrying/occupant protection device; (3) protective structures surrounding electric batteries; (4) plastic trim backing/reinforcement ribs or molding/casting parts that form backing/reinforcement ribs for components such as center consoles, HVAC systems, air ducts, arm rests, utility boxes, door trims, headliners, etc.; (5) energy absorbing devices for high performance and racing vehicles; or (6) deformable barriers.

The cellular structure 10 may be utilized in the aerospace, aeronautical, and defense industries to construct panels, floors, hulls, sub-structures for military or commercial aircrafts, space vehicles, space telescopes, space stations, or rockets.

The cellular structure 10 may be utilized in the train, locomotive, or high speed rail industries to construct interior linings, cab walls, interior doors, floors, roofs, or energy absorbing devices.

The cellular structure 10 may be utilized in the military, commercial, high speed vessel, and high-performance racing watercraft industries to construct components such as interior linings, cab walls, interior doors, floors, roofs, wing sails, or energy absorbing devices.

The cellular structure 10 may be utilized in the wind and solar energy industries to construct laminated skins for wind turbine blades, inserts for wind turbine blades, or backing structures for solar panels.

The cellular structure 10 may be utilized in various sporting good industries to construct snow boards, surf boards, skate boards, paddle boards, paddles, surfing fins, skis, gym floor cushions, seat cushions, fitness cushions, baseball/softball bases or plates, shoe insoles, shoe outsoles, shoe uppers, body impact protection, lightweight motor sport body armors (including inserts, protectors, pads), ping-pong and pickleball paddle pads, etc.

In the shipping and packaging industry, the cellular structure 10 may be utilized to construct paperboards or plastic boards used in package boxes, cushions, or pallets.

The cellular structure 10 may be utilized to construct furniture such as light weight furniture used in commercial and private aircrafts, high speed watercrafts, and recreational vehicles.

The cellular structure 10 may be utilized to construct home products such as mattresses, pillows, bath and floor cushions, and lightweight plastic shelving.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A cellular structure comprising:
a web of cells having shared walls, the cells each including two end walls joined at four end corners with two expanded fan-fold sidewalls that extend between the two end walls, wherein each sidewall has six planar sections forming three external corners and two internal corners.

2. The structure of claim 1, wherein the two end walls of each cell are parallel to each other.

3. The structure of claim 1, wherein the two end walls and the two expanded fan-fold sidewalls extend in one direction.

4. The structure of claim 3, wherein each cell has a cross-section that is oriented perpendicular to the one direction and an expected impact direction.

5. The structure of claim 1, wherein the web of cells is oriented to receive an impact from an impact direction, wherein the two end walls and the two expanded fan-fold sidewalls extend toward the impact direction when an impact is received.

6. A cellular structure comprising:
a plurality of walls extending in a longitudinal direction and forming a plurality of cells adjacently arranged along a laterally extending plane, each cell having a cross-section along the plane that includes fourteen sides formed by the plurality of walls, wherein the fourteen sides of each cell are joined to each other to form a closed loop and six outward extending protrusions.

7. The structure of claim 6, wherein each protrusion is formed by two of the fourteen sides of each cell.

8. The structure of claim 7, wherein an angle between the two of the fourteen sides that form each protrusion is an obtuse angle.

9. The structure of claim 7, wherein an angle between the two of the fourteen sides that form each protrusion is an acute angle.

10. The structure of claim 7, wherein a first set of three protrusions of the six protrusion of each cell extend outward in a first direction along the plane and a second set of three protrusions of the six protrusions of each cell extend outward in a second direction, that is opposite relative to the first direction, along the plane.

11. The structure of claim 10, wherein the protrusions of the first and second sets of three protrusions of each cell extend between two sides of the fourteen sides that form the ends of each cell, the two sides that form the ends of each cell being substantially parallel relative to each other.

12. The structure of claim 6, wherein a ratio between a longitudinal length and a thickness of each the plurality of walls forming the plurality of cells is at least one to one hundred.

13. The structure of claim 6, wherein the plurality of walls taper in the longitudinal direction such that a cross-sectional area of a central space defined by the fourteen sides of each cell decreases extending in the longitudinal direction.

14. The structure of claim 6, wherein at least one cell of the plurality of cells includes an internal support rib disposed within a central space defined by the fourteen sides and secured to at least two of the fourteen sides of the at least one cell.

15. The structure of claim 6, wherein a central space defined by the fourteen sides of at least one of the plurality of cells is filled with a deformable foam material.

16. A cell structure comprising:
a plurality of walls extending in a longitudinal direction and forming a cross-sectional area on a laterally extending plane, the cross-sectional area including fourteen sides formed by the plurality of walls, wherein the fourteen sides are joined to each other to form a closed loop and six outward extending protrusions.

17. The cell structure of claim 16, wherein each protrusion is formed by two of the fourteen sides.

18. The cell structure of claim 17, wherein a first set of three protrusions of the six protrusions extend outward in a first direction along the plane and a second set of three protrusions of the six protrusions extend outward in a second direction, that is opposite relative to the first direction, along the plane.

19. The cell structure of claim 18, wherein the protrusions of the first and second sets of three protrusions extend between two sides of the fourteen sides that form the ends of each cell, the two sides that form the ends of each cell being substantially parallel relative to each other.

20. The cell structure of claim 16, wherein the plurality of walls taper in the longitudinal direction such that a cross-sectional area of a central space defined by the fourteen sides decreases extending in the longitudinal direction.
